(19) United States
(12) Patent Application Publication
(10) Pub. No.: US 2018/0189794 A1
(43) Pub. Date: Jul. 5, 2018

(54) CUSTOMIZATION OF TRANSACTION CONVERSATIONS

(71) Applicant: OneMarket Network LLC, San Francisco, CA (US)

(72) Inventors: Tomas Ariel Campos, Oakland, CA (US); Rajiv Venkataramana Appana, Fremont, CA (US); Tushar Vaish, Milpitas, CA (US); Michael Scott Blandina, Parker, CO (US)

(73) Assignee: OneMarket Network LLC, San Francisco, CA (US)

(21) Appl. No.: 15/853,563

(22) Filed: Dec. 22, 2017

Related U.S. Application Data
(60) Provisional application No. 62/593,249, filed on Dec. 1, 2017.
(60) Provisional application No. 62/438,729, filed on Dec. 23, 2016.

(51) Int. Cl. G06Q 30/00; G06F 17/30; H04L 12/58; H04W 48/18; G06F 15/18; H04L 29/06

(52) U.S. Cl. CPC G06Q 30/016; G06F 17/30867; H04L 51/02; G06Q 30/0269; G06F 15/18; H04L 63/0815; H04W 48/18

(57) ABSTRACT

Disclosed are examples of systems, apparatus, methods and computer program products for providing customization of individualized transaction messages within a retailer network. Identity information for a customer during a retailer transaction is received, then a database of federated customer profiles is accessed to match and link a federated customer profile with the identity information. One or more messaging parameters are updated or added based on customer behavioral data in the federated customer profile, then a customized messaging template for the customer is provided based on the messaging parameters.

### CLAIM OF PRIORITY

This application claims priority under 35 U.S.C. § 119(e) to U.S. Provisional Patent Application Ser. No. 62/593,249, filed Dec. 1, 2017, entitled “CUSTOMIZATION OF TRANSACTION CONVERSATIONS”, which is hereby incorporated by reference in its entirety. This application further claims priority under 35 U.S.C. § 119(e) to U.S. Provisional Patent Application Ser. No. 62/438,729, filed Dec. 23, 2016, entitled “SYSTEMS AND METHODS TO PROVIDE LOCATION-DEPENDENT INFORMATION TO MOBILE DEVICES IN A CENTRE”, which is hereby incorporated by reference in its entirety.

### FIELD OF THE TECHNOLOGY

The present invention relates to retail transactions, and more specifically to providing customization of individualized transaction messages within a retailer network.

### BACKGROUND

After a customer completes a purchase transaction of goods or services in a “brick and mortar” (i.e., physical location) retail store, a store employee typically provides a printed paper receipt to the customer at the point of sale (POS). The customer may also be presented with the additional or alternative option of having a digital receipt emailed to him/her.

While this is a familiar process to customers, there are some limitations in the typical model of providing receipts. Customers often complain that printed receipts are not environmentally friendly, and losing receipts is a common issue. From a retailer's perspective, the engagement with a printed receipt is very low, since customers rarely return to a receipt to inspect it or follow up on the information contained in it. Email receipts, meanwhile, are falling out of favor with younger generations that increasingly prefer messaging channels to communicate. For retailers, email receipts do not provide a way to have a two-way dialogue with a customer and keep the customer engaged, satisfied, and interested. Neither printed nor email receipts provide a way to understand the customer on an ongoing basis after the point of sale.

### SUMMARY OF THE INVENTION

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide mechanisms for providing customization of individualized transaction messages within a retailer network. Identity information is received from a customer during a transaction between the customer and a retailer within the retailer network. A database of federated customer profiles is accessed, and the identity information is matched and linked with a federated customer profile from the database. One or more messaging parameters are updated or added based on previous customer behavioral data found within the federated customer profile, and then a customized message template is provided for the customer with respect to the transaction between the customer and the retailer. In some embodiments, the previous customer behavioral data can be supplemented or analyzed with customer profile information, customer insights inferred from the customer profile information, machine learning processes, predictive learning process and analysis, or a combination thereof.

In some embodiments, a two-way conversation between the customer and the retailer or retailer network can occur, individualized and based on the transaction, messaging channel, customer profile, customer insights, and other relevant data within the retailer network. In some embodiments, as the insight and understanding into a customer accrue from conversation history, messaging, interactions, transactions, inferred insights, and more, the conversation can be further individualized to suit a customer's needs and market more efficiently to the customer. In some embodiments, the process of individualized transaction messages or conversations being initiated with the customer after a transaction is performed in real time or substantially real time, effectively allowing for communication immediately or nearly immediately after a transaction is completed.

These and other features of the present invention will be presented in more detail in the following specification of certain embodiments of the invention and the accompanying figures which illustrate by way of example the principles of the invention.

### BRIEF DESCRIPTION OF THE DRAWINGS

The included drawings are for illustrative purposes and serve only to provide examples of possible structures and operations for the disclosed inventive systems, apparatus, methods and computer program products for providing customization of individualized transaction messages. These drawings in no way limit any changes in form and detail that may be made by one skilled in the art without departing from the spirit and scope of the disclosed implementations.

FIG. 1A shows an example of a system for providing customization of individualized transaction messages, in accordance with some implementations.

FIG. 1B shows an example of a system for providing customization of individualized transaction messages, in accordance with some implementations.

FIG. 2 shows a flowchart of an example of a method for providing transaction messages within a retailer network, performed in accordance with some implementations.

FIG. 3 shows a flowchart of an example of a method for providing an individualized transaction conversation within a retailer network, performed in accordance with some implementations.

FIG. 4 shows a flowchart of an example of a method for providing customization of individualized transaction messages, performed in accordance with some implementations.

FIG. 5 shows a flowchart of an example of a method for providing customization of individualized transaction messages, in accordance with some implementations.

FIG. 6A illustrates an initial product query screenshot, in accordance with some implementations.

FIG. 6B illustrates an example screenshot that includes product purchase information, in accordance with some implementations

FIG. 6C illustrates an example screenshot of additional product details that are presented to the customer, in accordance with some implementations.

FIG. 6D illustrates an options screenshot for presenting additional content, in accordance with some implementations.

FIG. 7 illustrates the training of a predictive model for providing transaction messages in a retailer network, in accordance with some implementations.

FIG. 8 illustrates an example of a federated customer profile, in accordance with some implementations.

FIG. 9A illustrates an example screenshot for managing customer transactions with federated customer profiles, in accordance with some implementations.

FIG. 9B illustrates an example screenshot for managing customer transactions with federated customer profiles, in accordance with some implementations.

FIG. 10 illustrates an example of a server, configured in accordance with one or more embodiments.

### DETAILED DESCRIPTION OF THE SPECIFIC EMBODIMENTS

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

For every transaction, a digital receipt is offered to the customer. If selected as an option, the digital receipt is sent electronically via email to the customer, along with additional content. Although this type of receipt can work well with some customers, the burden of accessing the receipt is on the customer. That is, the customer must remember to access her email and then open the digital receipt, as well as maintaining a copy of such receipt for later use, such as a product return or a question about a product.

Certain embodiments of the present invention automatically provide digital receipts for purchased goods, or other content related to customers, potential customers, transactions, retailers, or products within the retailer network, through a diverse set of messenger channels so that a customer can access the digital receipts and additional content through her preferred channel or even different preferred channels at different times. For instance, cross-channel mechanisms provide access to digital receipts and their associated additional content through messenger channels, such as SMS, Whatsapp, Messenger, WeChat, QQ, Snapchat, Fiber, Line, Telegram, Tango, Kik, etc. Said in another way, context around digital receipt use is maintained and available across multiple messaging channels.

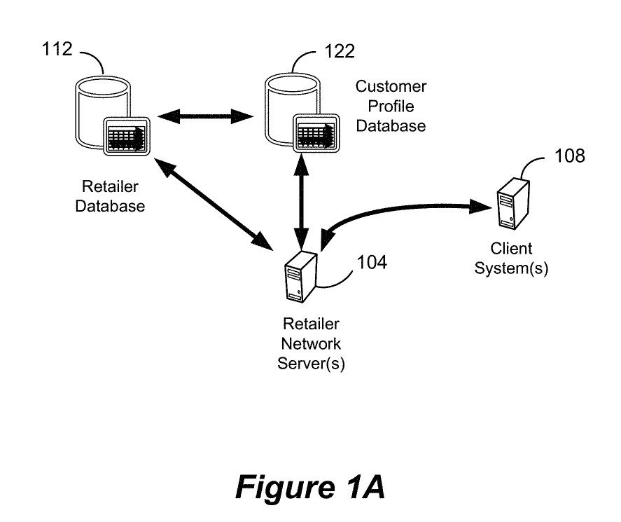

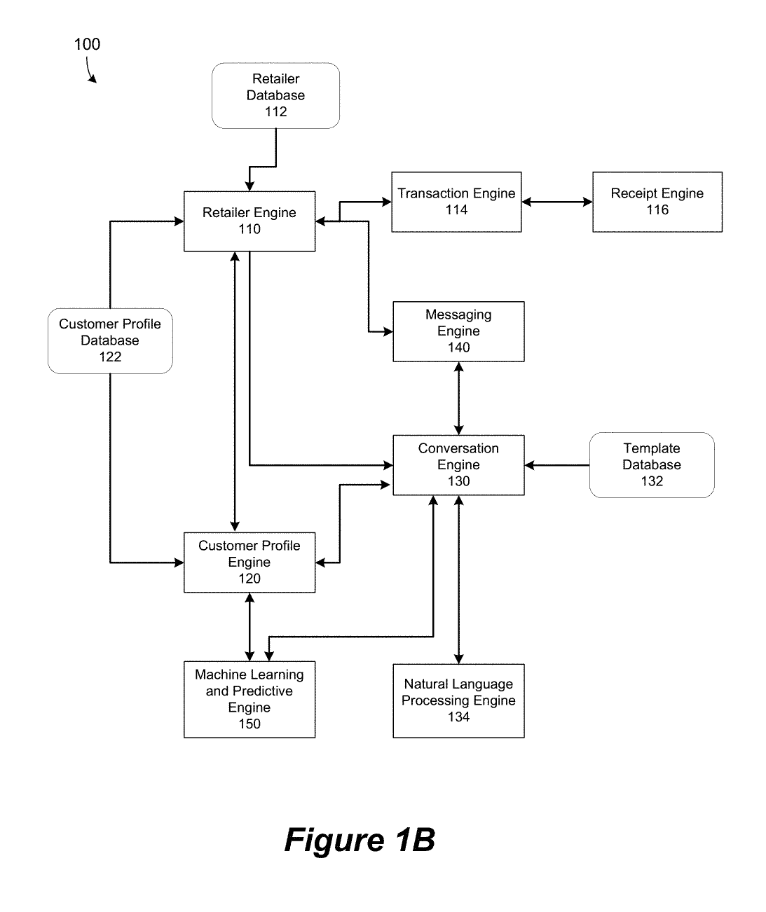

FIG. 1A shows an example of a system for providing transaction messages within a retailer network, in accordance with some implementations. The system in FIG. 1A includes a variety of different hardware and/or software components which are in communication with each other. The non-limiting example of FIG. 1A includes at least one retailer network server 104, at least one client system 108, at least one retailer database 112, and at least one customer profile database 122.

Retailer database 112 is a database that stores and maintains data pertaining to a plurality of retailers within a retailer network. In some implementations, the retailer database 112 is a multi-tenant database or other non-relational database management system. This database can include one or more records for each of a plurality of retailers within a retailer network. In some implementations, the database can include one or more shared tables, in which multiple retailers have records in the same table, and share many of the same standard objects and columns for their records.

Customer Profile Database 122 is a database that stores and maintains customer profiles. In some implementations, the customer profile database 122 may be a single customer profile database shared by retailers within the retailer network. In some implementations, various permissions are placed within the Customer Profile Database 122 such that limited views of the information are provided depending on the retailers' access permissions for tables and fields.

Retailer network server 104 may communicate with other components of the system. This communication may be facilitated through a combination of networks and interfaces. Retailer network server 104 may handle and process data requests from the client system 108. Likewise, retailer network server 104 may return a response to client system 108 after a data request has been processed. For example, retailer network server 104 may retrieve data from one or more databases, such as the retailer database 112 or the customer profile database 122. It may combine some or all of the data from different databases, and send the processed data to client system 108.

Client system 108 may be a computing device capable of communicating via one or more data networks with a server. Examples of client system 108 include a desktop computer or portable electronic device such as a smartphone, a tablet, a laptop, a wearable device, an optical head-mounted display (OHMD) device, a smart watch, etc. Client system 108 includes at least one browser in which applications may be deployed.

FIG. 1B shows an example of a system 100 for providing transaction messages within a retailer network, in accordance with some implementations. In some implementations, system 100 may represent a retailer network. In some implementations, a retailer network may be maintained and operated by a retail solutions provider. For example, a single retail solutions provider may offer a central hub for retailers to offer goods and services in a physical space, such as a mall. In some implementations, such a central hub can be a physical space, online marketplace, a mobile application, a sales cloud service, or any other physical or non-physical hub for retailers to be grouped under. A retailer network may offer centralized services, marketing data, customer-facing storefronts, exchanges between retailers, and other services for retailers and their customers.

Retailer Engine 110 is an engine for providing services that a retailer uses to interact within the retailer network or system 100. In some implementations, Retailer Engine 110 provides a complete set of services for retailers. In some implementations, retailer services may include services relating to or facilitating Point of Sale (POS) transactions, online retail services for customers, marketing campaigns, customer profiles, customer data analytics, and more. In some implementations, retailer engine 110 handles connectivity to retailers and retailer systems, including authentication of retailers within system 100. In some implementations, retailer engine 110 interfaces with message creation or conversation creation components of system 100 in order to deliver information and services relating to retailers, transactions, products, and more.

Retailer Database 112 is a database within the retailer network of some or all of the retailers within the retailer network. The Retailer Database 112 stores retailer information, retailer metadata, information about the financial or other aspects of the retailer with respect to the retailer network, and any other information relating to retailers within the retailer network. In some implementations, the retailer database 112 stores information relating to product configurations, inventory, and/or product data for one or more retailers.

Transaction Engine 114 is an engine that facilitates the transaction between a customer and a retailer. Customers may be shoppers who have purchased goods or services from the retailer or are about to purchase goods or services from the retailer, or have otherwise used or entered into a relationship with the retailer. Customers within the retailer network may potentially be customers of more than one retailer in the network. For example, a customer Mark might shop at one retailer for shoes, then go to a different retailer in the same retailer network for jeans. Each transaction with the retailer is facilitated by the Transaction Engine 114. In some implementations, the Transaction Engine 114 provides services for POS transactions, online transactions, credit card authorization and management, and otherwise facilitates the completion of transactions. In some implementations, system 100 stores transaction information, including any transaction updates or history that is received from or processed within the Retailer Engine. The Transaction Engine interfaces with the Retailer Engine 110 to receive data on retailers, products, and customers for processing the transactions.

Receipt Engine 116 is an engine of system 100 that generates and retrieves receipt information for customers who have completed transactions, and adds functionality to receipts in various ways. In some implementations, the retailer creates a receipt based on a transaction independently of the retailer network or system 100, and receipt engine 116 then recreates the receipt within a format compatible with the retailer network and its processes. Receipt engine 116 recreates the receipt with functionality and aspects that enable it to be understood by other components of system 100, and allows it to be passed on in various ways to others parts of system 100 and to customers in messages and/or conversations. In some implementations, receipts may be generated automatically. For example, automatic expense generation processes may automatically generate receipts in a number of ways. In some implementations, the receipts are generated in such a way that they are presentable to customers. When interfacing together, the Receipt Engine 116 and the Transaction Engine 114 allow for the creation and lifecycle management of orders. In some implementations, the Receipt Engine 116 is configured to create and receive receipts as well as send receipt events, including triggering events for other parts of the system 100, to deliver receipts to customers.

Customer Profile Engine 120 allows for storage, retrieval, and processing of customer profiles within the retailer network. In some implementations, customer profiles capture a partial or full view of a customer from multiple angles within the retailer network. In some implementations, portions of customer profiles or complete customer profiles are viewable by certain retailers in the retailer network, or all of the retailers in the retailer network. In some implementations, some or all of customer profiles can be shared among retailers, and the captured data from transactions and other pieces of customer data or knowledge can be used for each retailer in the network to gain a better understanding of the customer and use that understanding to provide more customized services for the customer. In some implementations, a customer profile may contain data such as customer metadata, information about the devices that a customer is using or has used, explicit customer preferences, implicit customer preferences or customer insights inferred from data within the retailer network, information about the messaging channels the customer prefers or has used before, and more.

Customer Profile Database 122 is a database that stores and maintains customer profiles. Customer Profile Engine 120 stores customer profiles and customer information within the Customer Profile Database 122, and retrieves information from the database as well. In some implementations, the customer database may be a single retailer database shared by retailers within the retailer network. In some implementations, various permissions are placed within the Customer Profile Database 122 such that limited views of the information are provided depending on the retailers' access permissions for tables and fields.

Conversation Engine 130 allows for the creation, processing, and analysis of individualized transaction conversations within the system 100. Individualized transaction conversations are conversations between one or more customers and one or more retailers, one or more customers and the retailer network provider, or some other such combination resulting in a conversation between any entities or agents of the retail network and one or more customers. In varying embodiments, the conversations are individualized such that they are tailored to the customer or customers' profile data, including the customer's preferences, needs, historical behavior from past transactions or conversations, the customer's interactions with retailers or retailer networks in the past, user device information, preferred messaging channels, and more. The Conversation Engine 130 interfaces with the Customer Profile Engine 120 to retrieve and process customer profile data, in order to individualize and tailor the conversation to a particular customer or customers. In some implementations, the Conversation Engine 130 selects a messaging template from the Template Database 132. In some implementations, messaging templates are templates that can be selected based on preferred messaging channel, user device currently being used, type of message being prepared for the customer, and more. In some implementations, the Conversation Engine 130 is configured to wait for and receive interactions from the customer within the conversation, then respond accordingly. In some implementations, interactions may include responding back by text, voice, or other means of communication, clicking on buttons, hovering on one or more items within the content of the conversation, or simply doing nothing for a period of time. In some implementations, responses may be dynamically generated based on the context of the conversation, the interaction being responded to, inferring one or more pieces of data about the customer's needs based on the customer profile, or any other relevant info relating to the conversation and the customer. For example, the Conversation Engine 130 may retrieve a customer profile showing that the customer does not like to be contacted more than once a day. Accordingly, the engine may opt to not respond to the interaction, but may rather wait until the next day to respond. In another example, the user may reply to a receipt asking for the expected date of delivery, and the Conversation Engine 130 can retrieve such data from the Transaction Engine 114 or Receipt Engine 116, then respond to the customer accordingly. Several other possibilities for responding to interactions can be contemplated. The Conversation Engine 130 also interfaces with a Messaging Engine 140, which generates and sends the individualized transaction messages that can begin a particular conversation with a customer, and a Natural Language Processing Engine 134, which parses user interactions and messages, analyzes them for meaning, intent, entities, attributes, and/or context, and sends information to the Conversation Engine 130 for generating responses and future conversations.

The Machine Learning and Predictive Engine 150 facilitates machine learning and predictive analysis within the system 100 for various processes, including customer insights and preferences, how to generate individualized transaction messages and responses to interactions, and more. In some implementations, the engine predicts customer behavior or preferences based on historical data about the customer and/or other customers within the retailer network. Machine learning and predictive processes are discussed further below.

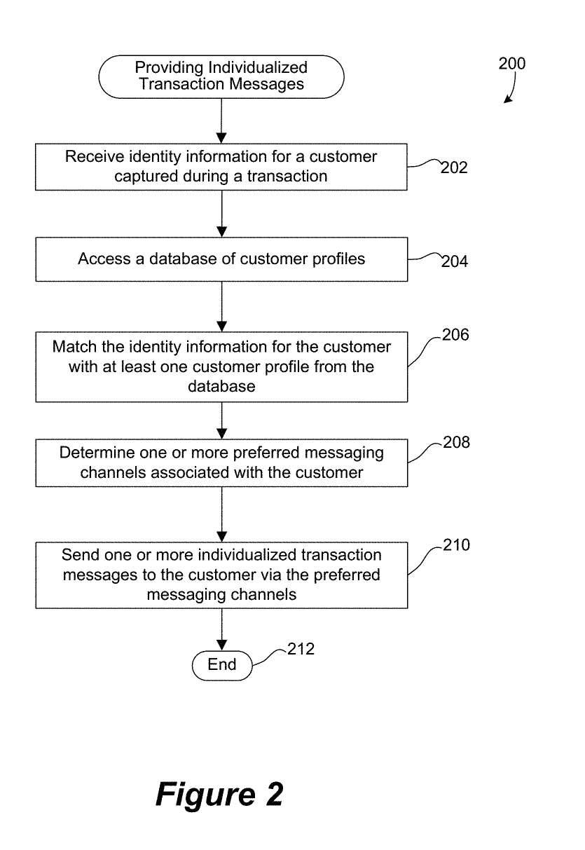

FIG. 2 shows a flowchart of an example of a method 200 for providing transaction messages within a retailer network, performed in accordance with some implementations. Method 200 and other methods described herein may be implemented using system 100 of FIG. 1B, although the implementations of such methods are not limited to system 100.

At block 202, system 100 receives identity information for a customer captured during a transaction. In some implementations, the transaction is between a customer and a retailer within the retailer network. In some implementations, this identity information is captured during a POS at a physical retailer space, while in other implementations, the identity information is captured via forms during an online transaction process. Identity information may include, for example, the customer's phone number, full name, address, credit card or payment information, age, gender, income, purchasing preferences, and preferred methods of messaging or communication.

At block 204, system 100 accesses a database of customer profiles. In some implementations, each customer profile is associated with one or more retailers in the retailer network. In some implementations, the database is the Customer Profile Database 122. The customer profile may contain any amount of a wide variety of customer information, including, for example, customer metadata, user devices currently or historically used, past purchasing history, customer demographic market, family information, customer insights inferred from other data, predictive information about the customer, locations the customer has visited, social media presences of the customer, and social graphs for the customer. In some implementations, customer profile information is stored in the database only if the customer grants permission.

At block 206, system 100 matches the identity information for the customer with at least one customer profile from the database. For example, the only identity information about the customer gained during the transaction may have been a customer phone number. System 100 matches the phone number with a customer profile with the same phone number. In some implementations, more than one customer profile may be matched with the identity information, each containing some overlapping content (for example, the multiple customer profiles may contain the same phone number but different email addresses or different names.) In some implementations, upon matching the identity information with a customer profile, system 100 links the identities, i.e. the identity information and the customer profile. In this way, a unified customer profile, or unified identity, can gradually emerge over time based on one or more transactions with retailers and additional information captured about the customer. In some implementations, once the identities are linked, system 100 can further make inferences based on the unified identity, including potentially predictive analysis and/or machine learning via the machine learning and predictive engine 150. In some implementations, various user IDs associated with the customer are federated into the customer profile, thus creating a federated customer profile and allowing several different identities from different transactions and retailers to link together to form a single, unified customer profile. In some implementations, a federated customer profile may contain information relating to one or more of: the retailer, one or more additional retailers, the transaction, one or more additional transactions, and one or more messaging channels. In some implementations, a federated customer profile can contain one or more pieces of information outside of the retailer network, such as an email address that hasn't been used within the retailer network.

At block 208, system 100 determines one or more preferred messaging channels associated with the customer. In some implementations, the preferred messaging channel or channels may be explicitly given by a customer, or explicitly appear in a customer profile or customer interaction. In some implementations, the preferred messaging channels may be implicitly determined rather than explicit. In some implementations, the preferred messaging channels are determined from the customer profile. For example, a customer may have indicated in a feedback form that the customer prefers phone and Facebook Messenger to other messaging channels. System 100 then infers which of the two options is the user's current preferred messaging channel, or infers that a combination of both are preferred, based on other pieces of customer profile info, such as which of the two options the user has historically used more often, or used more recently.

At block 210, system 100 sends one or more individualized transaction messages to the customer via the preferred messaging channels. In some implementations, multiple individualized transaction messages may be sent to the customer simultaneously, near-simultaneously, or successively in a single session. In some implementations, one or more individualized transaction messages are sent to multiple customers at once. In some implementations, the individualized transaction messages are related to the transaction, and are tailored and dynamically generated for the customer based on the customer's preferences and/or customer insights inferred from the customer profile information. In some implementations, one or more customer insights are generated for the customer based on the identity information for the customer, the retailer, and one or more pieces of data related to the transaction. The individualized transaction message or messages are then generated dynamically based on the generated customer insights. For example, system 100 may generate customer insights that the customer likes to shop for children's clothes at a particular children's clothing store on Sundays, and may tailor an individualized transaction message about children's clothing to appear on Saturday nights, when the customer may be preparing to shop for clothes. Furthermore, the system 100 may infer from the size and style of the products purchased in the past that the customer is buying the clothes for his daughter, age 8-10, and tailor the conversation accordingly.

In some implementations, an individualized transaction message can be a digital receipt for the transaction. In some implementations, the individualized transaction messages include selectable content that initiates, upon selection, an additional interactive process with the customer that is related to the transaction. Some examples include forms, fields, action buttons, links, and radio buttons. In some implementations, system 100 initiates the communication according to an Application Programming Interface (API) for the messaging channel, or capabilities stipulated elsewhere for the messaging channel. The method 200 of providing an individualized transaction message ends at block 212.

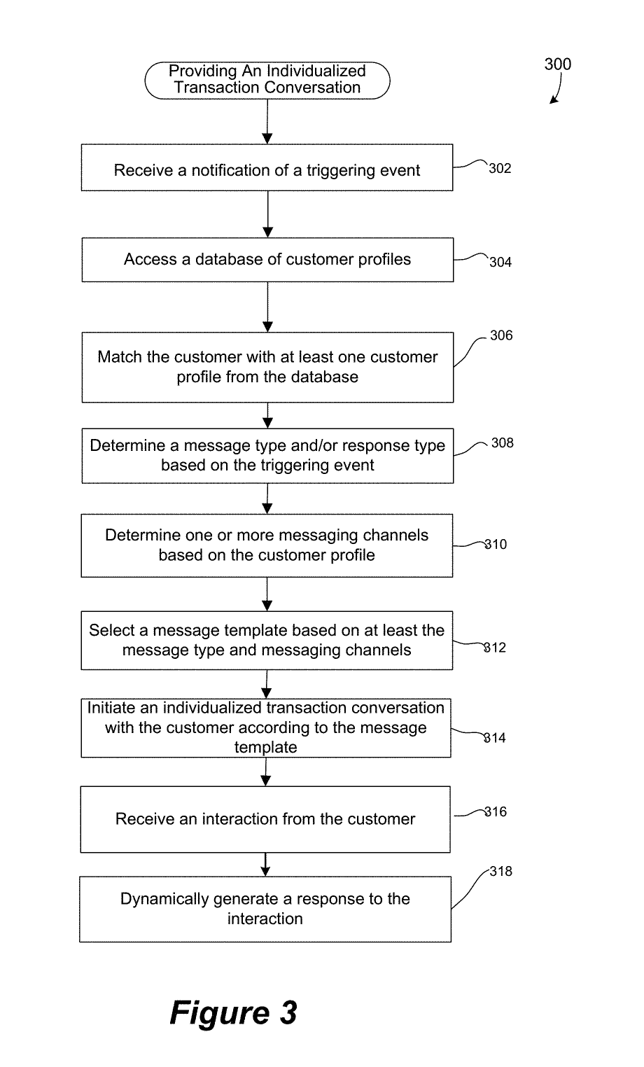

FIG. 3 shows a flowchart of an example of a method 300 for providing an individualized transaction conversation within a retailer network, performed in accordance with some implementations. Method 300 and other methods described herein may be implemented using system 100 of FIG. 1B, although the implementations of such methods are not limited to system 100.

At block 302, system 100 receives a notification of a triggering event. In some implementations, the triggering event is related to a customer and one or more retailers within the retailer network. A triggering event is some event that triggers the possibility of sending a message to or initiating a conversation with a customer within the retailer network. Examples of triggering events may include a completed transaction, which triggers the possibility of sending a digital receipt for the transaction to the customer; the delivery of an item, which triggers the possibility of sending a delivery notification to the customer about the item; or the occurrence of a two-week date since an item was delivered to the customer, which triggers the possibility of sending a feedback request to the user regarding whether the user liked the product. In some implementations, the triggering event can be sent from a chatbot, a retailer, a third party outside of the retailer network, or other source. In some implementations, notifications for triggering events can be sent from multiple sources at once, or multiple triggering events can be combined from one or more sources into a single notification. In some implementations, system 100 actively listens for notifications and triggering events or toggles between an active listening mode and a mode that disables listening based on various situations.

At block 304, system 100 access a database of customer profiles. In some implementations, each customer profile is associated with one or more retailers in the retailer network. In some implementations, the database is the Customer Profile Database 122. The customer profile may contain any amount of a wide variety of customer information, including, for example, customer metadata, user devices currently or historically used, past purchasing history, customer demographic market, customer insights inferred from other data, predictive information about the customer, and social media presences of the customer. In some implementations, customer profile information is stored in the database only if the customer grants permission.

At block 306, system 100 matches the customer with at least one customer profile from the database. For example, identity information about the customer may have been captured during a transaction with a retailer, such as a customer phone number. System 100 matches the phone number with a customer profile with the same phone number. In some implementations, upon matching the identity information with a customer profile, system 100 system 100 links the identities, i.e. the identity information and the customer profile. In this way, a unified customer profile, or unified identity, can gradually emerge over time based on one or more transactions with retailers and additional information captured about the customer. In some implementations, once the identities are linked, system 100 can further make inferences based on the unified identity, including potentially predictive analysis and/or machine learning via the machine learning and predictive engine 150. In some implementations, various user IDs associated with the customer are federated into the customer profile, thus creating a federated customer profile and allowing several different identities from different transactions and retailers to link together to form a single, unified customer profile. In some implementations, a federated customer profile may contain information relating to one or more of: the retailer, one or more additional retailers, the transaction, one or more additional transactions, and one or more messaging channels. In some implementations, a federated customer profile can contain one or more pieces of information outside of the retailer network, such as an email address that hasn't been used within the retailer network.

At block 308, system 100 determines a message type based at least on the triggering event. Message types correspond to messages that the system might send to the user in various situations. In some implementations, message types can include, for example, digital receipts, feedback requests, deals, retailer information, product information, customer information, concierge services, tracking information, returns and exchanges, related products, recommendations, and additional content about products, services, transactions, retailers, or the retailer network. Messages may also relate to allowing the customer to join an online community for fostering communication about the product or related topics, such as offering membership to a Facebook group dedicated to a trending style movement to a customer who has purchased a trending piece of clothing. In some implementations, system 100 determines a response type or interaction type instead of or in addition to the message type. For example, the response type may be determined based on a customer initiating a response to a message, indicating that she wishes to have a video about a product sent to her phone. System 100 then determines the response type based on the intent of the customer to have a video sent to her, formatted for a specific device and/or message channel.

At block 310, system 100 determines a preferred messaging channel associated with the customer. In some implementations, the preferred messaging channel is determined from the customer profile. For example, a customer may have indicated in a feedback form that the customer prefers phone and Facebook Messenger to other messaging channels. System 100 then infers which of the two options is the user's current preferred messaging channel based on other pieces of customer profile info, such as which of the two options the user has historically used more often, or used more recently.

At block 312, system 100 selects a message template based on at least the message type and message channel. In some implementations, the message template is selected from a list of message templates, such as the templates located within Template Database 132. In some implementations, the message template relates to instructions, steps, or rules associated with the determined message type and the determined messaging channel. For example, the Facebook Messenger API, or capabilities stipulated elsewhere for the Facebook Messenger, may determine that there is a limit to the number of messages that system 100 should send to customers within the Facebook Messenger messaging channel. Accordingly, the message template may stipulate that no more than X number of messages may be sent per day to a customer. In some implementations, the message template contains particular formatting and content that determines how a message is presented to a user. For instance, different templates may be associated with different users, resulting in different content and/or formatting being presented to different users for the same type of transaction. In some implementations, system 100 selects a message template further based on a customer profile, identity, persona, or customer insights. In some implementations, selecting a message template includes determining whether to send a detailed message or a simple message. This determination can be based on explicitly defined preferences or customer interactions, or implicitly inferred through customer preferences, the customer profile, customer insights, message history, and/or customer interactions.

At block 314, system 100 initiates an individualized transaction conversation with the customer. In some implementations, system 100 initiates the conversation according to the message template. In some implementations, system 100 initiates the conversation according to the triggering event. An individualized transaction conversation constitutes one or more messages involving a customer via a two-way messaging channel. In some implementations, the conversation takes the form of a series of messages between a retailer or retailer network and the customer, in which the customer interacts or responds to individualized transaction messages or responses from the retailer or retailer network, in a back-and-forth exchange. In some implementations, initiating the conversation includes initializing and sending a message via the determined preferred messaging channel.

At block 316, system 100 receives an interaction from the customer. In some implementations, the interaction can include a response via the messaging channel, a lack of response for a period of time, closing the messenger window or shutting down the application, clicking on one or more links within the messaging channel, requesting a move from one channel to another, or any other conceivable response within the individualized transaction conversation.

At block 318, system 100 dynamically generates a response to the interaction. In some implementations, the response is dynamically generated based on one or more predictions from customer profile info, based on predictive learning processes. In some implementations, system 100 determines whether or not to dynamically generate the response based on information about the customer in the customer profile. In some implementations, machine learning processes are executed based on information about the customer, transaction, retailer, or other aspect of the retailer network in order to dynamically generate the response to the interaction. In some implementations, the individualized transaction conversation can continue with interactions and responses until the customer terminates the conversation or indicates a desire to terminate the conversation, or system 100 determines that the conversation does not need a reply, or system 100 terminates the conversation.

In some implementations, system 100 provides for the branching of conversations based on the inputs or interactions with the customer. System 100 determines or infers elements of the conversation relating to the order or flow of the conversation, then dynamically responds to the customer based on this order. The order or flow of the conversation can be based on partial information. In some cases, system 100 may change course and modify the branching and order of the conversation at a later point in the conversation based on additional information.

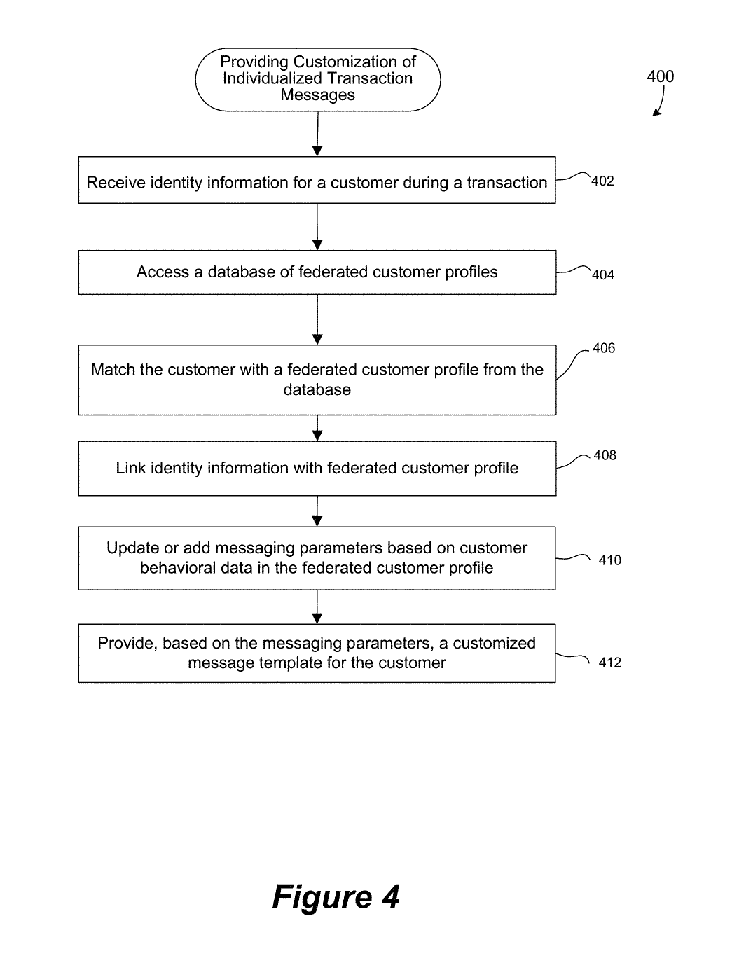

FIG. 4 shows a flowchart of an example of a method for providing customization of individualized transaction messages, performed in accordance with some implementations. Method 400 and other methods described herein may be implemented using system 100 of FIG. 1B, although the implementations of such methods are not limited to system 100. At block 402, system 100 receives identity information for a customer captured during a transaction. In some implementations, the transaction is between a customer and a retailer within the retailer network. In some implementations, this identity information is captured during a POS at a physical retailer space, while in other implementations, the identity information is captured via forms during an online transaction process. Identity information may include, for example, the customer's phone number, full name, address, credit card or payment information, age, gender, income, purchasing preferences, and preferred methods of messaging or communication.

At block 404, system 100 accesses a database of federated customer profiles. Each of the federated customer profiles is associated with one or more customer identities from a variety of possible sources and entities. A federated customer profile can be thought of as a customer identity that encapsulates one or more linked, authenticated customer identities. In many services with customer login processes, creating new logins and passwords can introduce friction for the customer. Customers may already be authenticated via one or more retailers or messaging channels. For example, consumers may already be authenticated via one or more of Facebook Messenger, Facebook, Google, Gmail, Google Home or Assistant, WhatsApp, Microsoft Outlook, and more. In addition, retailers such as Nordstrom, Macy's, or Sephora may have already set up authentication and customer identities and accounts within their systems. With a federated customer profile, if a customer's identity information does not appear to be authenticated within the retailer network yet, system 100 may want to authenticate that customer via one or more existing authenticated identities or accounts instead of forcing the user to re-authenticate or create a new login.

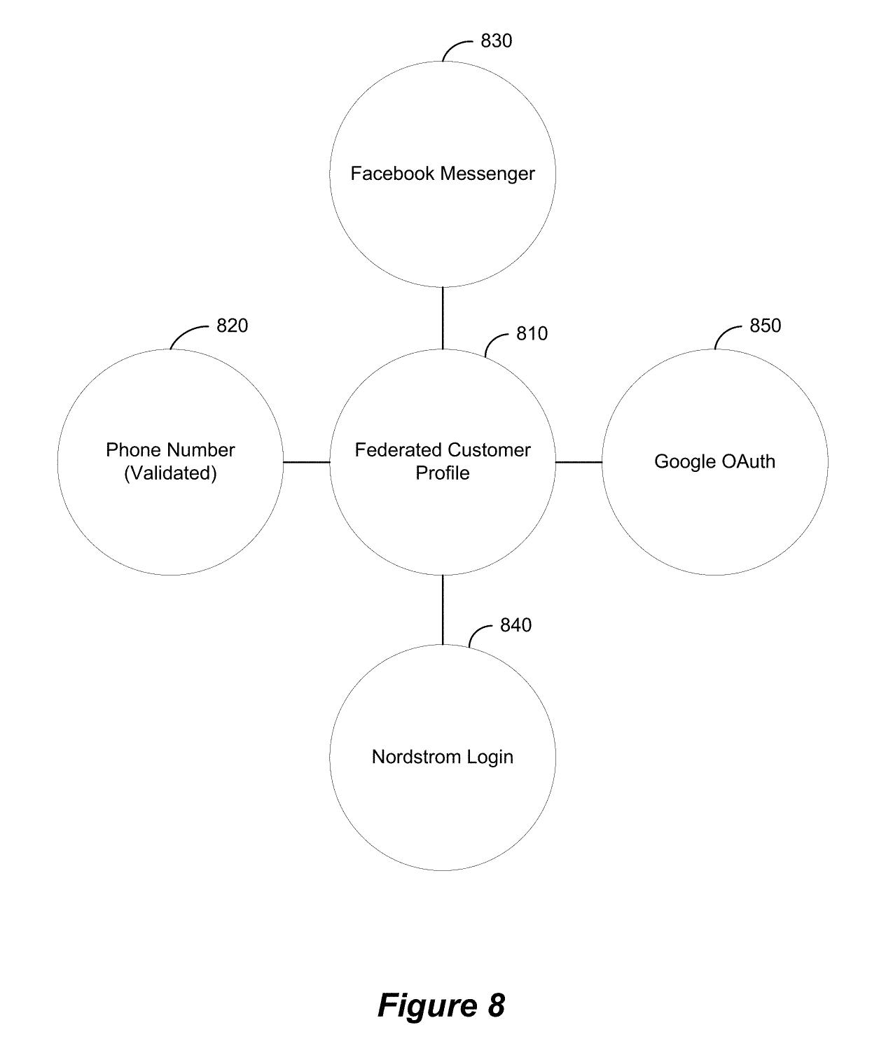

FIG. 8 illustrates an example of a federated customer profile, in accordance with some implementations. Within this example of a federated customer profile, a federated customer profile 810 exists within the retailer network, and acts as a federated customer profile within the customer profile database. The retailer network customer profile is linked to four existing identities: a validated phone number 820, a Facebook Messenger account 830, a retailer login 840 (in this example, Nordstrom is the retailer), a Google OAuth instance 850 which has authenticated the user within Google services.

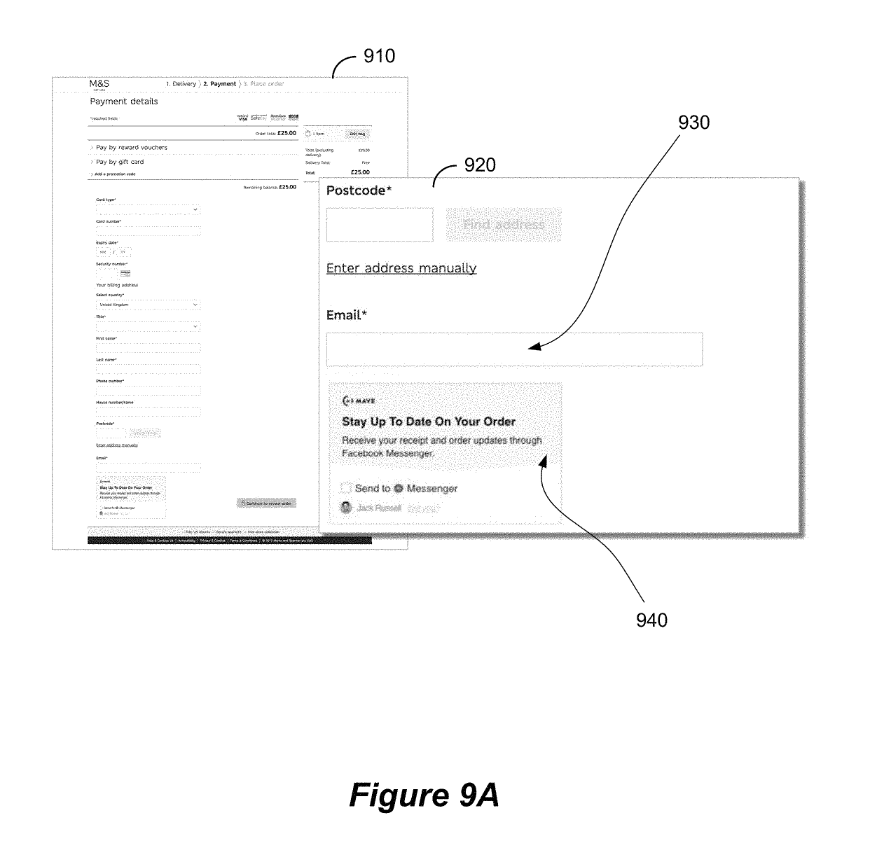

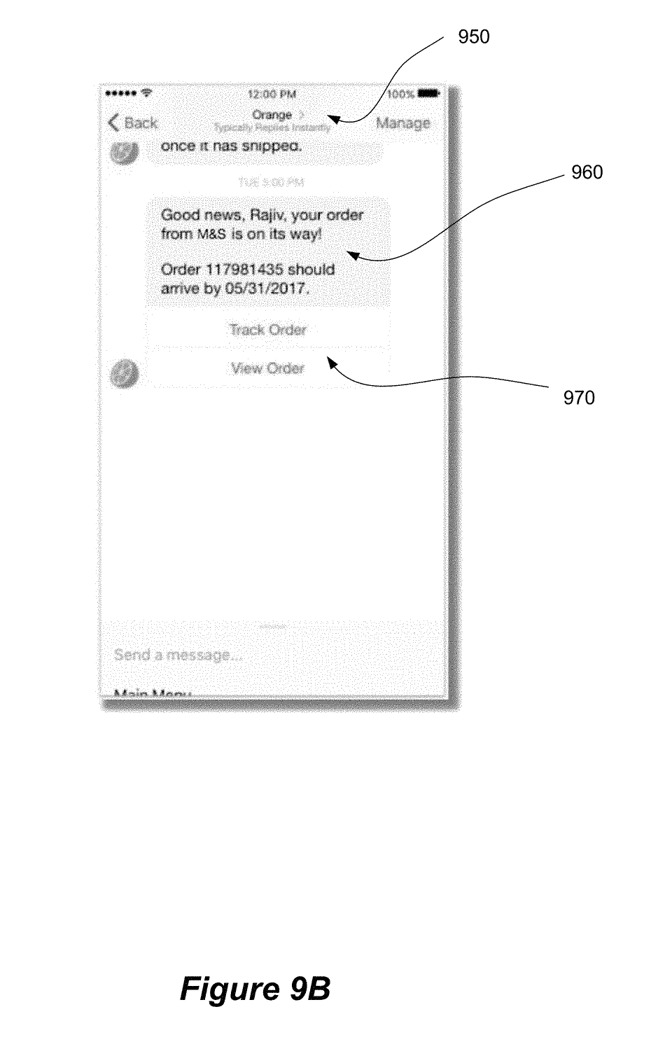

FIG. 9A and FIG. 9B illustrate example screenshots for managing customer transactions with federated customer profiles, in accordance with some implementations. In the example screenshot of FIG. 9A, a customer of a retailer M&S is in the process of completing an online transaction with the retailer. A page 910 appears with forms for filling out payment details. In the magnification of the screenshot 920, the customer is asked to enter a postcode or enter an address manually; enter an email address 930; and is given the option 940 to keep updated on the order by having a receipt and order updates sent to the customer's Facebook Messenger account. The option 940 is already populated with an authenticated Facebook Messenger account for the user, because the customer's federated customer profile 810 is linked to the Facebook Messenger account 830 for the customer. System 100 accesses a database of federated customer profiles, and matches the customer's provided identity information (including website cookies) with the federated customer profile.

In the example screenshot of FIG. 9B, the customer has agreed to have a receipt and order updates sent to his Facebook Messenger account. In a Facebook Messenger chat window 950, the customer receives an order update 960 informing him that the order from M&S has been shipped, and should arrive by May 31, 2017. The customer is also given options 970 to track the order, or view the order. These options may lead to additional chat window messages, links to within the M&S or retailer network sites, links to external third party sites, or some combination thereof. In this way, federated customer profiles allow an interoperational flow to take place between a retailer's transaction process, authentication, linking of a user to other identities, and allowing a user to receive one or more messages on other messaging channels, without introducing friction to the customer with re-authentication or sign-in procedures, creating new logins, and other time-intensive processes that may may the customer lose attention or interest.

Returning to FIG. 4 and block 404, in some implementations, each federated customer profile is associated with one or more retailers in the retailer network. In some implementations, the federated customer profile database database is the Customer Profile Database 122. In some implementations, at least one of the linked customer identities in a federated customer profile contain customer behavioral data for one or more transactions between a customer and a retailer in the retailer network. In some implementations, at least one of the customer identities includes identity information or other information from outside of the retailer network. Federated customer profiles may contain any amount of a wide variety of customer information and customer behavioral data, including, for example, customer metadata, user devices currently or historically used, past purchasing history, customer demographic market, family information, customer insights inferred from other data, predictive information about the customer, locations the customer has visited, social media presences of the customer, and social graphs for the customer. In some implementations, federated customer profile information is stored in the database only if the customer grants permission.

At block 406, system 100 matches the identity information for the customer with a federated customer profile from the database. For example, the only identity information about the customer gained during the transaction may have been a customer phone number. System 100 matches the phone number with a federated customer profile linked to the same phone number which has already been validated within the retailer network.

At block 408, upon matching the identity information with a federated customer profile, system 100 links the identity information with the federated customer profile. In this way, a unified customer profile, or unified identity, can gradually emerge over time based on one or more transactions with retailers and additional information captured about the customer. In some implementations, once the identities are linked, system 100 can further make inferences based on the unified identity, including potentially predictive analysis and/or machine learning via the machine learning and predictive engine 150. In some implementations, various user IDs associated with the customer are federated into the customer profile, thus forming an updated federated customer profile and allowing several different identities from different transactions and retailers to link together to form a single, unified customer profile. In some implementations, a federated customer profile may contain information relating to one or more of: the retailer, one or more additional retailers, the transaction, one or more additional transactions, and one or more messaging channels. In some implementations, a federated customer profile can contain one or more pieces of information outside of the retailer network, such as an email address that hasn't been used within the retailer network.

At block 410, system 100 updates or adds one or more messaging parameters to the federated customer profile, based on customer behavioral data in the federated customer profile. In some implementations, the updating or adding is based on customer behavioral data from the current transaction, previous transactions, previous interactions, messaging or conversation history, customer preferences, customer insights inferred from the federated customer profile, and more. In some implementations, system 100 generates one or more of the messaging parameters. In some implementations, this generation involves employing one or more machine learning and or predictive analysis techniques or processes, as described further below. In some implementations, the customer behavioral data within the federated customer profile is used as training data for the one or more machine learning or predictive analysis processes. Other customers' behavioral data and federated customer profiles may also be used in some way as training data for the machine learning or predictive analysis processes. In some implementations, the messaging parameters include one or more messaging channel preferences associated with one or more message types. The messaging channel preferences may include, for example, one or more preferred messaging channels, a priority or order of messaging channels, messaging channels to use for specific interactions or message types, and more. In some implementations, one or more of the messaging parameters are related to customer-directed discounts. For example, system 100 may add a messaging parameter that stipulates that a customer prefers to receive 20% or more sales items on products relating to smart phone accessories.

At block 412, system 100 provides a customized message template for the customer, based on the messaging parameter. In some implementations, one or more individualized transaction messages and/or individualized transaction conversations can be generated and sent to the customer based on the customized message template. In some implementations, the customized message template provides a set of rules for generating a message or conversation for a customer. By following the set of rules in the customized message template, system 100 can provide individualized and customized conversations and messages directed specifically at the customer. In some implementations, the customized message template relates to the current transaction between the customer and the retailer, and the message or conversation that is generates can relate specifically to that customer, transaction, and retailer, and include retailer preferences for the conversation or message.

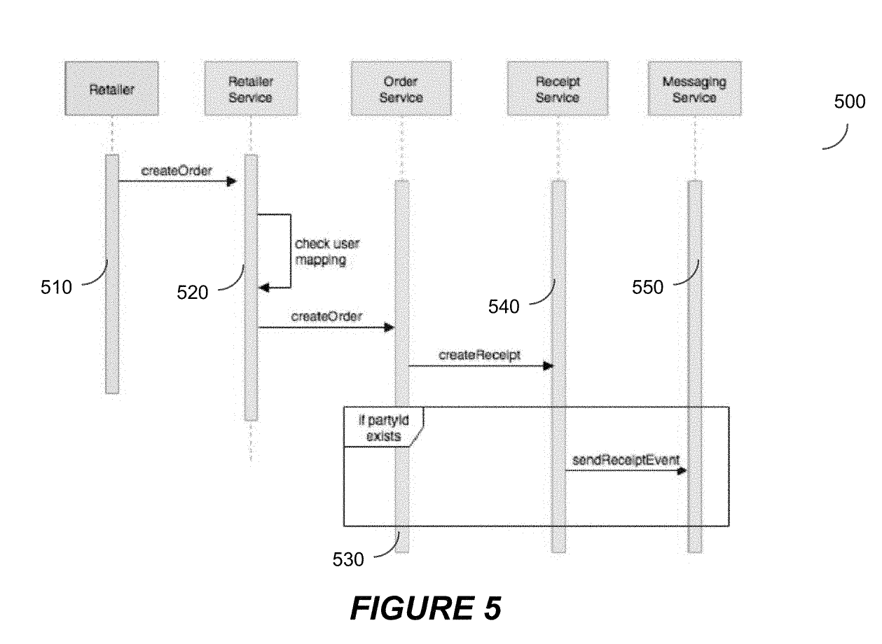

FIG. 5 shows a flowchart of an example of a method 400 for providing transaction messages within a retailer network, in accordance with some implementations. At block 510, a retailer within the retailer network creates an order within the system relating to a customer and a transaction. At block 520, the Retailer Engine 110, or Retailer Service herein, accesses the Customer Profile Database 122 and matches the customer information to one or more customer profiles in the database, then sends the information to the Transaction Engine 114, or Order Service herein. At block 530, the Receipt Engine 116, or Receipt Service herein, determines whether a match was found for a customer profile, then generates a receipt for the transaction. At block 540, if a match for the profile was found, then the Messaging Engine 140 and Conversation Engine 130, or Messaging Service herein, determine a preferred message channel from the customer profile information, then the Receipt Engine 116 sends the receipt to the Messaging Engine 140 and Conversation Engine 130. From there, at Block 550, the Messaging Engine 140 and Conversation Engine 130 initiate a conversation on the preferred messaging channel and send the receipt via an individualized transaction message to the customer. The conversation content and timing may also depend on the particular template that is associated with the particular user for the transaction. That is, different users may experience different conversation flows for the same transaction type.

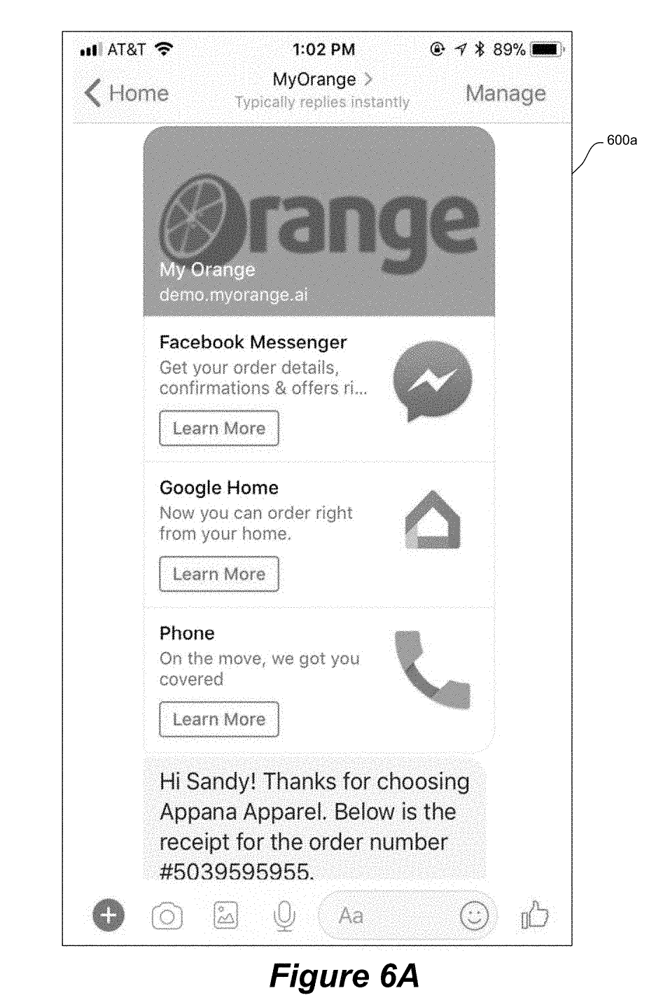

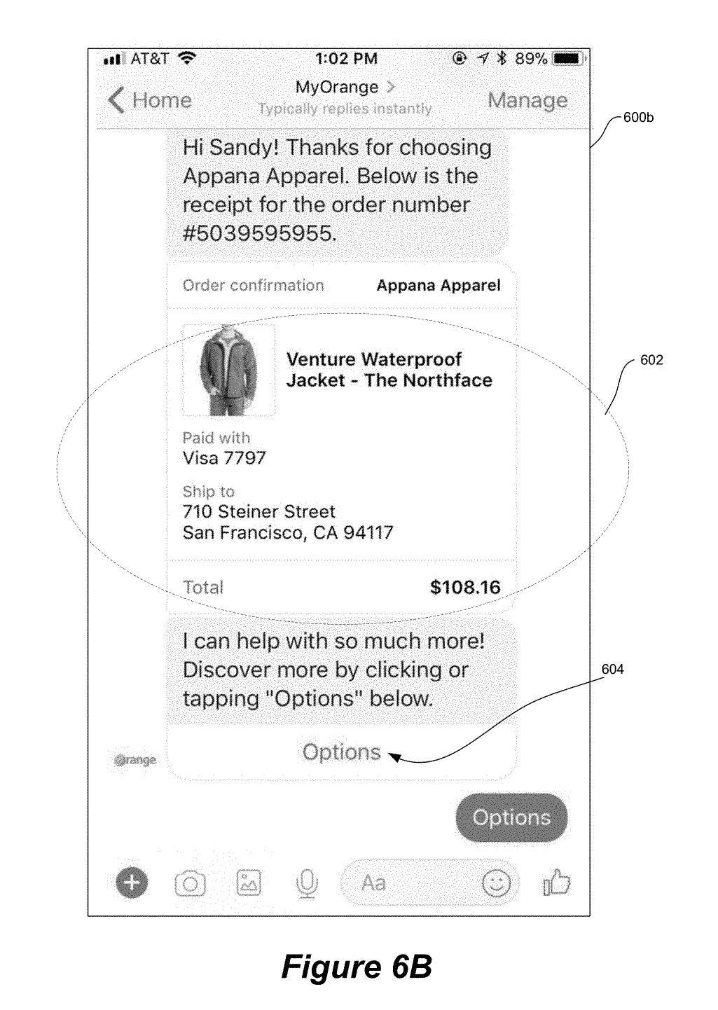

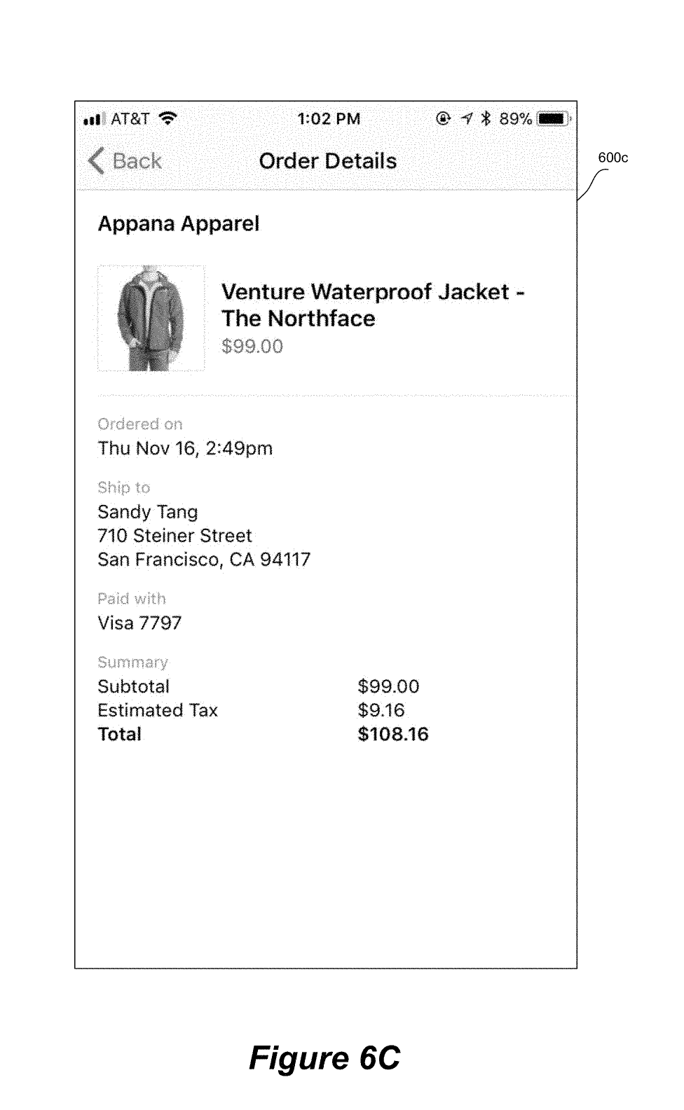

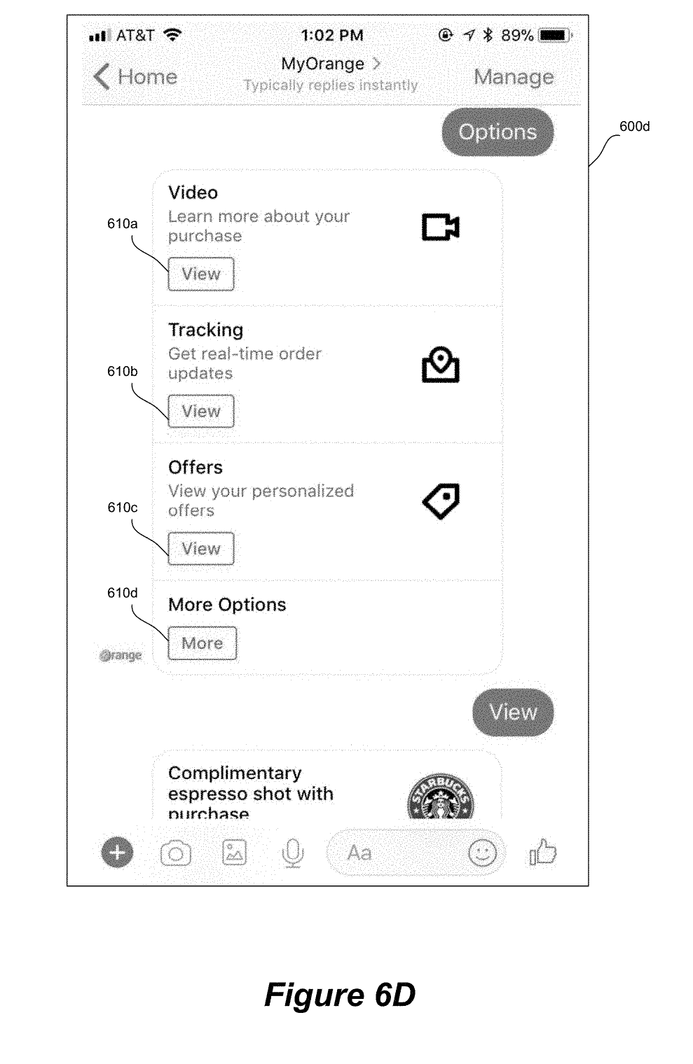

FIG. 6A illustrates an initial product query screenshot 600a that is presented to a customer Sandy after she asks her digital assistant (Orange) for further information pertaining to a particular transaction, in accordance with one example implementation of the present invention. In this example, Sandy has purchased an item from Appana Apparel, and she has requested to see a receipt for such purchased item. This initial request triggers a conversation with respect to her purchased item. Via the digital assistant, Sandy can also choose to continue various aspects of the conversation about the Appana Apparel item on various platforms, such as Facebook Messenger, Google Home, or telephone call.

Upon initiation (or continuation) of a conversation pertaining to the purchased item, Sandy may be presented with any suitable type of information to enhance her experience with respect to the purchased item. FIG. 6B illustrates an example screenshot 600b that includes product purchase information 602 and a simple “Options” button 604 for selecting additional content, including interactive processes, which relate to the particular purchased product. In this example, the product purchase information 602 is presented in a simplified manner for presentation through Sandy's digital assistant application interface on her cellphone. In general, the product purchase information may be tailored to the particular messaging channel, user device, and customer preference. In this example, the presented product purchase information 602 includes a thumbnail picture of the purchased product (Venture Waterproof Jacket-Northface), payment type (Visa), and shipping address (710 Steiner Street, San Francisco), and purchase price ($108.16).

Any suitable options may be presented if the user selects the options button 604, and such presentation format and content may also be based on various factors, such as particular messaging channel, user device, and customer preference. FIG. 6C illustrates an example screenshot 602c of additional product details that are presented to the customer upon selection of the options button 604. Such product details, of course, provide more information than the initial screenshot for such transaction. As shown, Sandy can see purchase date, taxes paid, and product price. This detailed product information may have also been presented in the initial transaction screenshot, for example, if suitable for the particular messaging channel (e.g., in an email).

FIG. 6D illustrates an options screenshot 602d for presenting additional content, including interactive content that relates to the transaction or product. As shown, example transaction options may include a video 610a for learning more about the product, tracking 610b of a product shipment, and personalized offers 610c that may be determined based on the current product purchase, as well as previous purchases through the retail network. Other options 610d may also be accessible.

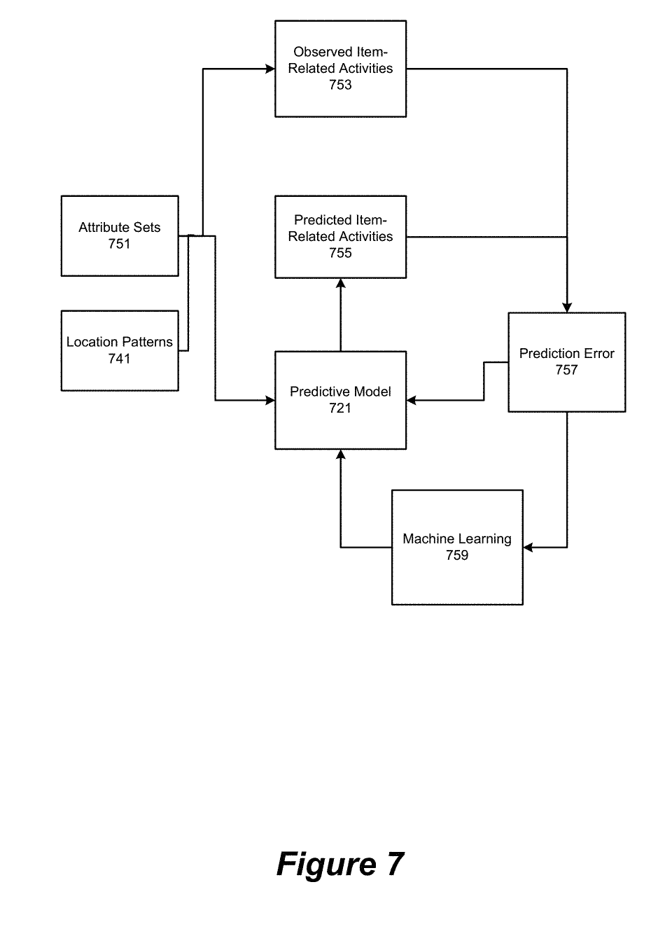

FIG. 7 illustrates the training of a predictive model 721 for providing transaction messages in a retailer network, in accordance with some implementations. In some implementations, the method of FIG. 6 can be used by the system 100 to train the machine learning and predictive engine 150 illustrated in FIG. 1B. In some implementations, the data in retailer database 112, customer profile database 122, or both may be used as training data for the predictive model 721.

In FIG. 7, system 100 generates attribute sets for customers or client devices associated with customers. The characteristics of customers are represented by the attribute sets. An attribute set includes parameters extracted from affinity data and user attributes obtained by one or more retailers in the retailer network. In some implementations, parameters may be extracted from customer profiles in the customer profile database 122, data from the retailer database 112, customer insights inferred from one or more pieces of customer data, client device information, customer preferences, or any other aspect of information or metadata relating to customers within system 100. The more extensive the parameters used in an attribute set, the more predictive power the resulting predictive model 721 has.

In some implementations, system 100 also generates location patterns 741 from physical sites associated with the retailer network or retailers, such as sequences of locations in areas within the physical site, dwell times in areas, number of separate visits to the areas, pairs of first and last visited areas in each trip to the physical site, etc.

In some implementations, the attribute sets 751 of customers, and potentially their location patterns 741, are connected to the observed item-related activities 753 as the training targets. Examples of observed item-related activities 753 may include items purchased (which may be purchased online, in retail stores, at physical sites, or other locations), or responses to individualized transaction messages announcing or recommending products. A positive response may be indicated by a trip to a location of a recommended product, a purchase transaction of an announced product, an interaction inquiring about further information relating to an announced or recommended product, a user selection of a link in a message related to a product, a user search of the announced product following an announcement, or the playback of a video featuring a recommended item, for example.

System 100 applies the attribute sets 751 of customers, and potentially their location patterns 741, to the predictive model 721 to generated the predicted item-related activities 755, and then computes the statistical prediction error 757 from the difference between the observed item-related activities 753 and the predicted item-related activities 755. In some implementations, one or more machine learning algorithms 759 are applied to train the predictive model 721 to reduce the statistical prediction error 757 or reduce another measurement of prediction errors.

In some implementations, attribute sets 751 are used to predict products of interest, including products that retailers may wish to recommend to customers or potential customers. In some implementations, location patterns 741 are used to predict areas of interest. The system 100 then ranks the items of interest in view of areas of interest where the items are available. For example, an item of interest that is on a predicted path of a mobile device in a physical location can be provided with a ranking score that is higher than a different item of interest that is away from the predicted path of the mobile device in the physical location. In some implementations, one or more highest ranking items can be selected for generating transaction messages. The transmissions of the messages can be timed according to the current location of the user or predicted future location of the user, such that the messages are relevant to the locations and areas that the user is likely to visit soon (e.g., without significant deviation from a predicted path of the user.)

System 100 digitizes physical and non-physical interactions of the user, both in physical locations and in online marketplaces or other online locations, by stitching together behavioral and transaction data of the users, and connecting that information to a digital persona for a personalized information service, such as a targeted offer or navigational guidance. System 100 can direct the user to physical or online locations of products based on the preferences and/or affinity of the user to retailers, products, physical sites, and items purchased in the past by users having attributes and/or location patterns similar to those of the user.

For example, in various implementations, system 100 can acquire: user information from large audience data providers; geo-location, demographic, and/or behavioral data of the users; SKU-level data of items purchased by users, such as from various points of sales; and loyalty program information of the users. System 100 can select, for example, advertisements, offers, or coupons to push to the user, based on predicting: what the user will purchase; what offers will or will not resonate; price sensitivity of the user; how much a user is likely to spend when using loyalty points; what life events are likely to occur; a lifetime value of the user; and/or what types of retailers will drive the most footfall and spending within a physical site such as a mall.

In one example, Sumi is an eighteen-year-old student shopping for the new semester. She browses jeans online at home, walks along Market Street, and visits the physical stores of retailers Nordstrom and Macy's. She uses a mobile application for social networking installed on her mobile device to send pictures of jeans to friends.

The retailer network server 104 tracks the demographics and/or psychographics attributes of Sumi, the geo-locations of Sumi, her online browsing activities, and/or offline shopping histories to infer her preferences and customer insights regarding her behavior and future behavior. For example, after obtaining her permission, the retailer network server 104 tracks cookies on websites to build an online behavior profile for Sumi which is matched to an advertising ID of Sumi's mobile devices. Geo-aware retailers and/or the retailer network, also obtaining her permission, track the locations of Sumi via GPS using their Software Development Kit (SDK) embedded in mobile applications running in Sumi's mobile devices. The retailer network server 104 and/or system 100 link one or more pieces of personally identifying information of Sumi, such as an email address, to a complete profile of Sumi, purchase history of Sumi, and loyalty data provided by retailers to the information server. For example, Sumi's profile may indicate that Sumi has bought clothes in the past from retailer Nordstrom in a San Francisco mall, since the information server has obtained the purchase information from the store and added her purchase data into her profile.

Based on the available information about Sumi, the system 100 infers her intent to purchase the latest jeans and back-to-school supplies, and predicts that she will respond to a 10% discount. At her next visit to one of Nordstrom's physical locations or to the Nordstrom web site, system 100 identifies and delivers a real-time offer of the store to her mobile device. For example, Sumi gets an advertisement via the mobile application for social networking running in her mobile device, where the advertisement offers 10% off True Religion jeans at Nordstrom for the next hour. She buys jeans and a t-shirt, and system 100 stores her response and purchase data in the customer profile database 122, which can be used to train the predictive model 721 in predicting the response of similar users to similar advertisements.

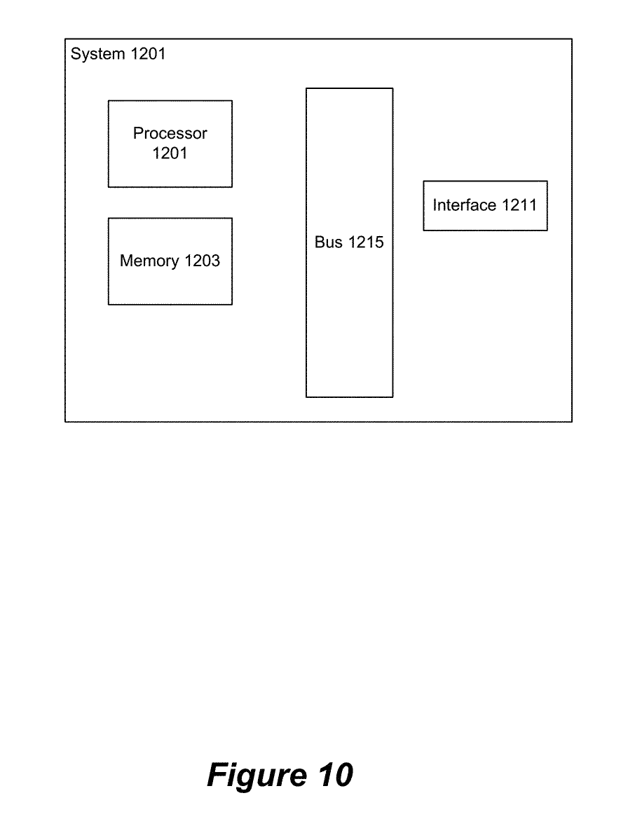

FIG. 10 illustrates one example of a server. According to particular embodiments, a system 1100 suitable for implementing particular embodiments of the present invention includes a processor 1201, a memory 1203, an interface 1211, and a bus 1215 (e.g., a PCI bus or other interconnection fabric) and operates as a counter node, aggregator node, calling service, zookeeper, or any other device or service described herein. Various specially configured devices can also be used in place of a processor 1201 or in addition to processor 1201. The interface 1211 is typically configured to send and receive data packets over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. Although a particular server is described, it should be recognized that a variety of alternative configurations are possible.

Because such information and program instructions may be employed to implement the systems/methods described herein, the present invention relates to machine readable storage media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method for providing customization of individualized transaction messages within a retailer network, the method comprising:
receiving identity information for a customer captured during a transaction between the customer and a retailer within the retailer network;
accessing a database of federated customer profiles, each federated customer profile associated with one or more customer identities;
matching the identity information for the customer with a federated customer profile from the database of federated customer profiles;
linking the identity information for the customer with the federated customer profile;
updating or adding one or more messaging parameters based on customer behavioral data in the federated customer profile; and
providing, based on the updated or added messaging parameters, a customized message template for the customer with respect to the transaction between the customer and the retailer.

2. The method of claim 1, wherein at least one of the customer identities contains customer behavioral data for one or more transactions between a customer and a retailer in the retailer network.

3. The method of claim 1, further comprising:
generating the one or more messaging parameters, the generating comprising employing one or more machine learning processes and/or predictive analysis processes.

4. The method of claim 3, wherein the customer behavioral data in the federated customer profile is used as training data for the one or more machine learning processes and/or predictive analysis processes.

5. The method of claim 1, wherein the one or more messaging parameters includes one or more messaging channel preferences associated with one or more message types.

6. The method of claim 1, wherein the one or more messaging parameters include messaging parameters related to customer-directed discounts.

7. The method of claim 1, wherein the customized message template comprises one or more rules for transaction messages or transaction conversations corresponding to the transaction.

8. The method of claim 1, wherein at least one of the customer identities includes customer information from outside of the retailer network.

9. The method of claim 1, wherein the federated customer profile comprises at least one of: a messenger identity, an OAuth identity, a validated phone number, and a retailer-based identity.

10. A system for providing customization of individualized transaction messages within a retailer network, the system configurable to cause:
receiving identity information for a customer captured during a transaction between the customer and a retailer within the retailer network;
accessing a database of federated customer profiles, each federated customer profile associated with one or more customer identities;
matching the identity information for the customer with a federated customer profile from the database of federated customer profiles;
linking the identity information for the customer with the federated customer profile;
updating or adding one or more messaging parameters based on customer behavioral data in the federated customer profile; and
providing, based on the updated or added messaging parameters, a customized message template for the customer with respect to the transaction between the customer and the retailer.

11. The system of claim 10, wherein at least one of the customer identities contains customer behavioral data for one or more transactions between a customer and a retailer in the retailer network.

12. The system of claim 10, further configurable to cause:
generating the one or more messaging parameters, the generating comprising employing one or more machine learning processes and/or predictive analysis processes.

13. The system of claim 10, wherein the one or more messaging parameters includes one or more messaging channel preferences associated with one or more message types.

14. The system of claim 10, wherein the customized message template comprises one or more rules for transaction messages or transaction conversations corresponding to the transaction.

15. The system of claim 10, wherein at least one of the customer identities includes customer information from outside of the retailer network.

16. The system of claim 10, wherein the federated customer profile comprises at least one of: a messenger identity, an OAuth identity, a validated phone number, and a retailer-based identity.

17. A computer program product comprising computer-readable program code capable of being executed by one or more processors when retrieved from a non-transitory computer-readable medium, the program code comprising instructions configurable to cause:
receiving identity information for a customer captured during a transaction between the customer and a retailer within the retailer network;
accessing a database of federated customer profiles, each federated customer profile associated with one or more customer identities;
matching the identity information for the customer with a federated customer profile from the database of federated customer profiles;
linking the identity information for the customer with the federated customer profile;
updating or adding one or more messaging parameters based on customer behavioral data in the federated customer profile; and
providing, based on the updated or added messaging parameters, a customized message template for the customer with respect to the transaction between the customer and the retailer.

18. The computer program product of claim 17, wherein at least one of the customer identities contains customer behavioral data for one or more transactions between a customer and a retailer in the retailer network.

19. The computer program product of claim 17, the program code comprising instructions further configurable to cause
generating the one or more messaging parameters, the generating comprising employing one or more machine learning and/or predictive analysis processes.

20. The computer program product of claim 17, wherein the federated customer profile comprises at least one of: a messenger identity, an OAuth identity, a validated phone number, and a retailer-based identity.
